(19) United States
(12) Patent Application Publication
(10) Pub. No.: US 2021/0363878 A1
(43) Pub. Date: Nov. 25, 2021

(54) Electromagnetic Telemetry Using Non-Polarizing Electrodes

(71) Applicant: Halliburton Energy Services, Inc., Houston, TX (US)

(72) Inventors: Glenn Andrew Wilson, Houston, TX (US); Luis Emilio San Martin, Albuquerque, NM (US)

(73) Assignee: Halliburton Energy Services, Inc., Houston, TX (US)

(21) Appl. No.: 16/623,233

(22) PCT Filed: Jan. 18, 2019
(86) PCT No.: PCT/US2019/014298

§ 371 Date: Dec. 16, 2019

(51) Int. Cl. E21B 47/12; G01V 11/00

(52) U.S. Cl. CPC E21B 47/12; G01V 11/002

(57) ABSTRACT

A method and system for communicating with a bottom hole assembly from the surface. The method may comprise drilling into a formation with the bottom hole assembly, disposing at least one porous pot on the surface, emitting an electromagnetic field from the transmitter, sensing a voltage of the electromagnetic field with the at least one porous pot, and measuring the voltage with the porous pot. A system may comprise a downhole tool, wherein the downhole tool is disposed on the bottom hole assembly, a drill string, wherein the drill string is attached to the bottom hole assembly and a well head, a drill bit, and at least one porous pot, wherein the at least one porous pot is disposed on the surface and wherein the at least one porous pot is configured to sense and measure a voltage from the electromagnetic field.

### BACKGROUND

Boreholes drilled into subterranean formations may enable recovery of desirable fluids (e.g., hydrocarbons) using a number of different techniques. Communication with a bottom hole assembly (BHA) during drilling operations may be beneficial to operators as a BHA traverses through different formations.

In general, electromagnetic (EM) telemetry may be used to communicate with a BHA during drilling operations, measurement-while-drilling operations (MWD), and logging-while-drilling (LWD) operations. Currently, a bi-directional EM telemetry system, which may comprise a transmitter (or receiver), may consist of a voltage applied (or measured) across a gap sub in the BHA. The receiver (or transmitters) may measure (or apply) a voltage received between the BHA and a surface-deployed counter electrode. This surface-deployed counter electrode may be a single metal, multiple metal stakes, or an adjacent well or rig that electrically couples to the earth. Currently, voltages emitted by the BHA that may be below 1 kHz may be problematic for metal stakes to measure the voltage. A new device that may measure a voltage signals below 1 kHz may be beneficial.

### BRIEF DESCRIPTION OF THE DRAWINGS

These drawings illustrate certain aspects of some examples of the present invention, and should not be used to limit or define the invention.

FIG. 1 illustrates an example of a drilling system.

FIG. 2 illustrates an example of an electromagnetic telemetry system and an earth model.

FIG. 3 illustrates a received voltage calculated as a line integral at a surface between a well head and a counter electrode.

FIG. 4 is a graph of a calculated electric field distribution in the earth model.

FIG. 5 is a graph of a received voltage where the received voltage is a line integral of an electromagnetic field along a surface.

FIG. 6 illustrates an example of a non-polarizing electrode.

FIG. 7 is a graph of a capacitive electrode recording a signal.

### DETAILED DESCRIPTION

Provided are systems and methods for receiving a voltage between a well head and a counter electrode with EM telemetry. Specifically, systems and methods may include the utilization of porous pot electrodes.

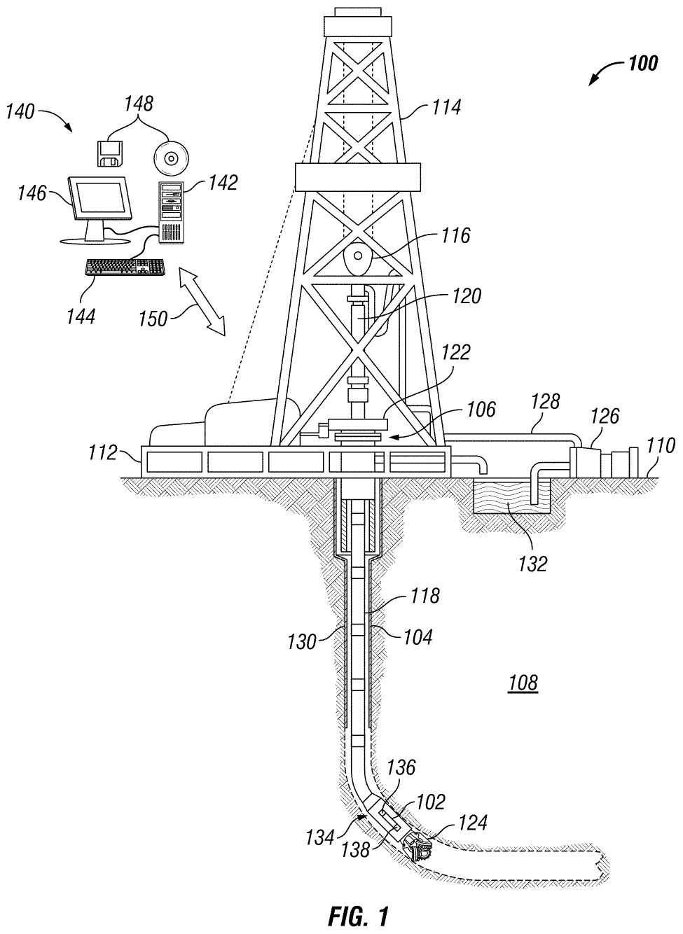

FIG. 1 illustrates an example of a drilling system 100 in which a downhole tool 102 may be disposed. As illustrated, borehole 104 may extend from a wellhead 106 into a formation 108 from surface 110. Generally, borehole 104 may include horizontal, vertical, slanted, curved, and other types of wellbore geometries and orientations. Borehole 104 may be cased or uncased. In examples, borehole 104 may comprise a metallic material. By way of example, the metallic member may be a casing, liner, tubing, or other elongated steel tubular disposed in borehole 104.

As illustrated, borehole 104 may extend through formation 108. As illustrated in FIG. 1, borehole 104 may extending generally vertically into formation 108, however borehole 104 may extend at an angle through formation 108, such as horizontal and slanted wellbores. For example, although FIG. 1 illustrates a vertical or low inclination angle well, high inclination angle or horizontal placement of the well and equipment may be possible. It should further be noted that while FIG. 1 generally depicts a land-based operation, those skilled in the art may recognize that the principles described herein are equally applicable to subsea operations that employ floating or sea-based platforms and rigs, without departing from the scope of the disclosure.

As illustrated, a drilling platform 112 may support a derrick 114 having a traveling block 116 for raising and lowering drill string 118. Drill string 118 may include, but is not limited to, drill pipe and coiled tubing, as generally known to those skilled in the art. A kelly 120 may support drill string 118 as it may be lowered through a rotary table 122. A drill bit 124 may be attached to the distal end of drill string 118 and may be driven either by a downhole motor and/or via rotation of drill string 118 from surface 110. Without limitation, drill bit 124 may include, roller cone bits, PDC bits, natural diamond bits, any hole openers, reamers, coring bits, and the like. As drill bit 124 rotates, it may create and extend borehole 104 that penetrates various subterranean formations 108. A pump 126 may circulate drilling fluid through a feed pipe 128 to kelly 120, downhole through interior of drill string 118, through orifices in drill bit 124, back to surface 110 via annulus 130 surrounding drill string 118 and into a retention pit 132.

With continued reference to FIG. 1, drill string 118 may begin at wellhead 106 and may traverse borehole 104. Drill bit 124 may be attached to a distal end of drill string 118 and may be driven, for example, either by a downhole motor and/or via rotation of drill string 118 from surface 110. Drill bit 124 may be a part of bottom hole assembly (BHA) 134 at distal end of drill string 118. As will be appreciated by those of ordinary skill in the art, bottom hole assembly 134 may be a measurement-while drilling (MWD) or logging-while-drilling (LWD) system. Bottom hole assembly 134 may further comprise downhole tool 102. Downhole tool 102 may be disposed on the outside and/or within bottom hole assembly 102. In examples, downhole tool 102 may be an electromagnetic (“EM”) telemetry system. Downhole tool 102 may comprise a plurality of transmitters 136 and receivers 138. During operations, transmitter 136 may broadcast an electromagnetic field from downhole tool 102. In examples, the transmitter 136 may be a an antenna, a coil, an electrode, and/or the like. Transmitter 136 may be connected to information handling system 140, which may further control the operation of transmitter 136. Additionally, receiver 138 may measure and/or record an electromagnetic field broadcasted from transmitter 136. Receiver 138 a an antenna, a coil, an electrode, and/or the like. Receiver 138 may transfer recorded information to information handling system 140. Information handling system 140 may control the operation of receiver 138. For example, an electromagnetic field emitted from transmitter 136 may be altered by formation 108. The altered electromagnetic field may be sensed and transformed into a recorded signal by receiver 138. The recorded signal may be transferred to information handling system 140 for further processing. In examples, there may be any suitable number of transmitters 136 and/or receivers 138, which may be controlled by information handling system 140. Information and/or measurements may be processed further by information handling system 140 to determine properties of borehole 104, fluids, and/or formation 108.

Systems and methods of the present disclosure may be implemented, at least in part, with information handling system 140. Information handling system 140 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 140 may be a processing unit 142, a network storage device, or any other suitable device and may vary in size, shape, performance, functionality, and price. Information handling system 140 may include random access memory (RAM), one or more processing resources such as a central processing unit (CPU) or hardware or software control logic, ROM, and/or other types of nonvolatile memory. Additional components of the information handling system 140 may include one or more disk drives, one or more network ports for communication with external devices as well as various input and output (I/O) devices, such as a input device 144 (e.g., keyboard, mouse, etc.) and a video display 146. Information handling system 140 may also include one or more buses operable to transmit communications between the various hardware components.

Alternatively, systems and methods of the present disclosure may be implemented, at least in part, with non-transitory computer-readable media 148. Non-transitory computer-readable media 148 may include any instrumentality or aggregation of instrumentalities that may retain data and/or instructions for a period of time. Non-transitory computer-readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Without limitation, bottom hole assembly 134, transmitter 136, and/or receiver 138 may be connected to and/or controlled by information handling system 140, which may be disposed on surface 110. Without limitation, information handling system 140 may be disposed down hole in bottom hole assembly 134. Processing of information recorded may occur down hole and/or on surface 110. Processing occurring downhole may be transmitted to surface 110 to be recorded, observed, and/or further analyzed. Additionally, information recorded on information handling system 140 that may be disposed down hole may be stored until bottom hole assembly 134 may be brought to surface 110. In examples, information handling system 140 may communicate with bottom hole assembly 134 through a communication line (not illustrated) disposed in (or on) drill string 118. In examples, wireless communication may be used to transmit information back and forth between information handling system 140 and bottom hole assembly 134. Information handling system 140 may transmit information to bottom hole assembly 134 and may receive as well as process information recorded by bottom hole assembly 134. In examples, a downhole information handling system (not illustrated) may include, without limitation, a microprocessor or other suitable circuitry, for estimating, receiving and processing signals from bottom hole assembly 134. Downhole information handling system (not illustrated) may further include additional components, such as memory, input/output devices, interfaces, and the like. In examples, while not illustrated, bottom hole assembly 134 may include one or more additional components, such as analog-to-digital converter, filter and amplifier, among others, that may be used to process the measurements of bottom hole assembly 134 before they may be transmitted to surface 110. Alternatively, raw measurements from bottom hole assembly 134 may be transmitted to surface 110.

Any suitable technique may be used for transmitting signals from bottom hole assembly 134 to surface 110, including, but not limited to, wired pipe telemetry, mud-pulse telemetry, acoustic telemetry, and electromagnetic telemetry. While not illustrated, bottom hole assembly 134 may include a telemetry subassembly that may transmit telemetry data to surface 110. Without limitation, an electromagnetic source in the telemetry subassembly may be operable to generate pressure pulses in the drilling fluid that propagate along the fluid stream to surface 110. At surface 110, pressure transducers (not shown) may convert the pressure signal into electrical signals for a digitizer (not illustrated). The digitizer may supply a digital form of the telemetry signals to information handling system 140 via a communication link 150, which may be a wired or wireless link. The telemetry data may be analyzed and processed by information handling system 140.

As illustrated, communication link 150 (which may be wired or wireless, for example) may be provided that may transmit data from bottom hole assembly 134 to an information handling system 140 at surface 110. Information handling system 140 may include a processing unit 142, a video display 146, an input device 144 (e.g., keyboard, mouse, etc.), and/or non-transitory computer-readable media 148 (e.g., optical disks, magnetic disks) that may store code representative of the methods described herein. In addition to, or in place of processing at surface 110, processing may occur downhole.

Bottom hole assembly 134 may comprise a transmitter 136 and/or a receiver 138. In examples, bottom hole assembly 134 may operate with additional equipment (not illustrated) on surface 110 and/or disposed in a separate well measurement system (not illustrated) to record measurements and/or values from formation 108. During operations, transmitter 136 may broadcast an electromagnetic field from bottom hole assembly 134. Transmitter 136 may be connected to information handling system 140, which may further control the operation of transmitter 136. Additionally, receiver 138 may measure and/or record signals broadcasted from transmitter 136. Receiver 138 may transfer recorded information to information handling system 140. Information handling system 140 may control the operation of receiver 138. For example, the broadcasted signal from transmitter 136 may be reflected by formation 108. The reflected signal may be recorded by receiver 138. The recorded signal may be transferred to information handling system 140 for further processing. In examples, there may be any suitable number of transmitters 136 and/or receivers 138, which may be controlled by information handling system 140. Information and/or measurements may be processed further by information handling system 140 to determine properties of borehole 104, fluids, and/or formation 108. It should be noted that properties of borehole 104, formation 108, and of bottom hole assembly 134 may be transmitted in-situ through the emitted electromagnetic field to surface 110 for in-situ communication.

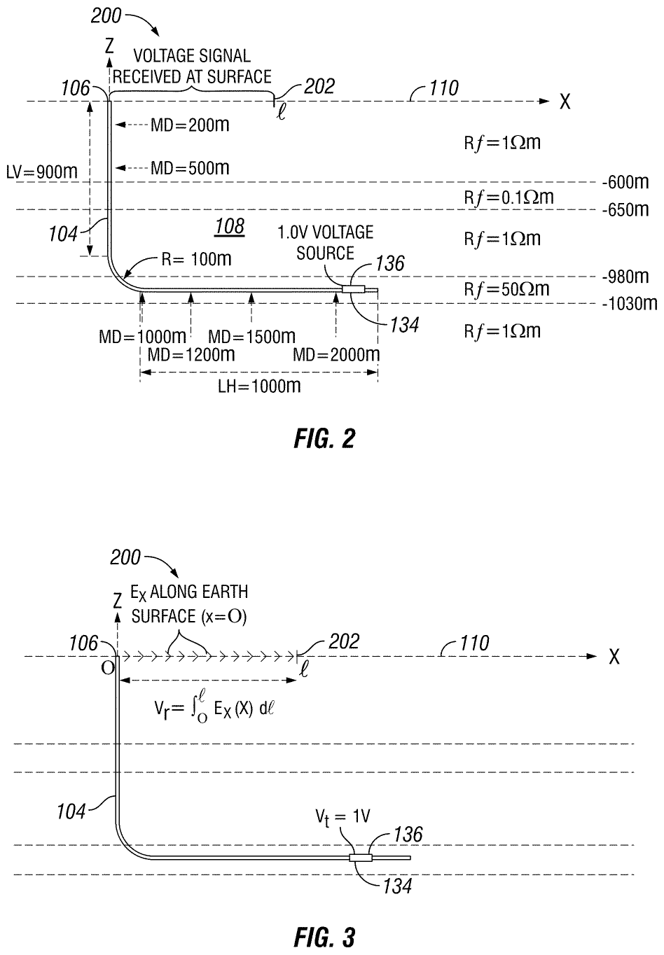

For example, as discussed above, downhole tool 102 may be an electromagnetic (EM) telemetry system. In examples, the EM telemetry system may also function and operate as a method for communicating from bottom hole assembly 134 to surface 110, such that drilling dynamics data may allow faster drilling, while formation evaluation (i.e., MWD and LWD) data may allow accurate well placement to maximize reservoir value. In examples, the drilling dynamics data may include position of the BHA 134, direction of the BHA 134, angle of the BHA 134, speed of the BHA 134, formation properties measured by the BHA 134, and/or the like. EM telemetry systems typically may operate at frequencies between about 1 Hz and about 50 Hz, with data rates nominally between 3 and 12 bps from a limited number of communication channels. As shown in FIGS. 2 to 5, an EM telemetry system 200 may receive a voltage from bottom hole assembly 134, specifically transmitter 136, where bottom hole assembly 134 is disposed in borehole 104. The voltage from the electromagnetic field emitted by transmitter 136 may be measured between wellhead 106 and a counter electrode 202. The voltage may carry drilling dynamic data, which may be recorded by a porous pot.

FIGS. 2 and 3 illustrate an example of EM telemetry system 200 and an earth model. As illustrated BHA 134 may be disposed within formation 108 at any distance from surface 110 both horizontally and/or vertically from wellhead 106. It should be noted that formation 110 may include any number of layers, which may have a specific resistance for each layer, as illustrated in FIG. 2. Furthermore, transmitter 136 may act as a voltage source as transmitter 136 emits an electromagnetic field, which may be sensed by counter electrode 202. It should be noted that the counter electrode 202 may be a porous pot.

FIG. 3 illustrates an example of the received voltage being calculated as the line integral of the electric at surface 110 between wellhead 106 and counter electrode 202. The voltage may be calculated as follows:

Vᵣ=∫₀^{l} Eₓ(x)dl (1)

where Eₓ is the voltage along the surface and Vᵣ is voltage at a receiver, in this case a porous pot.

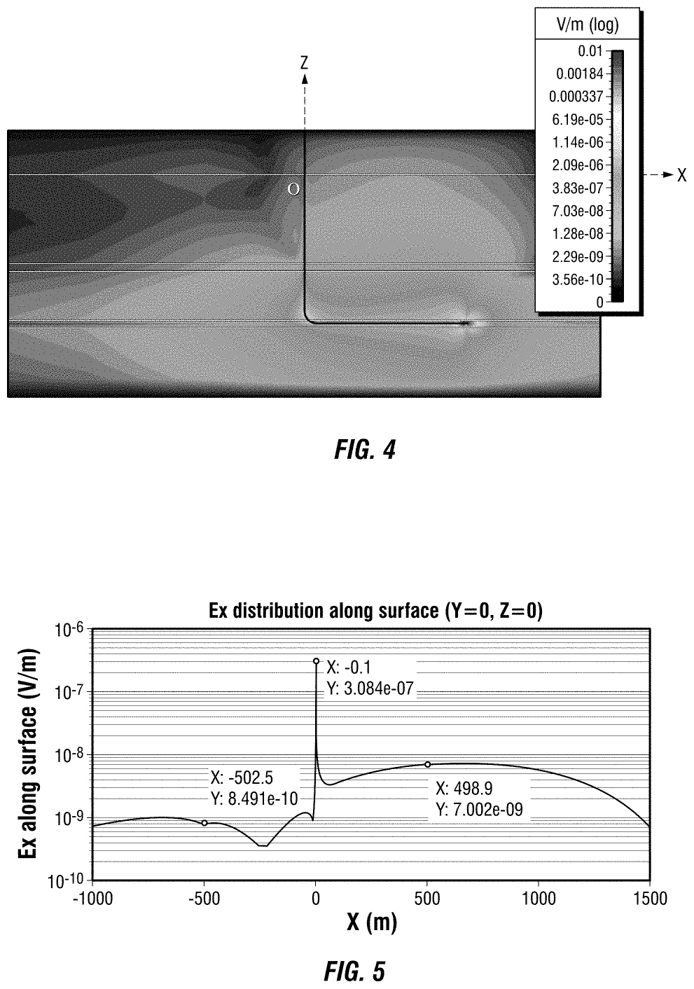

FIGS. 4 and 5 illustrate examples of the calculated electric field distribution in the earth model of FIG. 3. The received voltage may be the line integral of the electric field along the surface.

As illustrated, the high-input impedance receiver 138 (or low-output impedance transmitters 136) in downhole tool 102 may measure (or apply) a voltage received between bottom hole assembly 134 and a surface-deployed counter electrode 202, as best seen on FIGS. 2 and 3. This surface-deployed counter electrode 202 may be either a metal stake, multiple metal stakes, a porous pot, or an adjacent well or rig.

In examples, counter electrode 202 may be a porous pot electrode. Porous pot electrodes may be electro-chemical transducers for which electrical conduction changes from ionic in the formation to electronic in the metal electrode, as illustrated in FIG. 4. This change in conduction may involve electrochemical reactions, with the net effect that electrons are released by ions in formation fluids around one electrode while electrons are simultaneously accepted by ions and returned to the circuit at the other electrode. The electrochemical reactions at the electrodes, involving gain or loss of electrons, are oxidation-reduction reactions. In examples, silver may have the lowest potential difference between the metal and its salt, with lead next, then copper. As such, porous pot electrodes may include Ag—AgCl, Pb-PbCl2, and Cu—CuSO4. It should be noted that the metal electrode may be silver, lead, and/or copper.

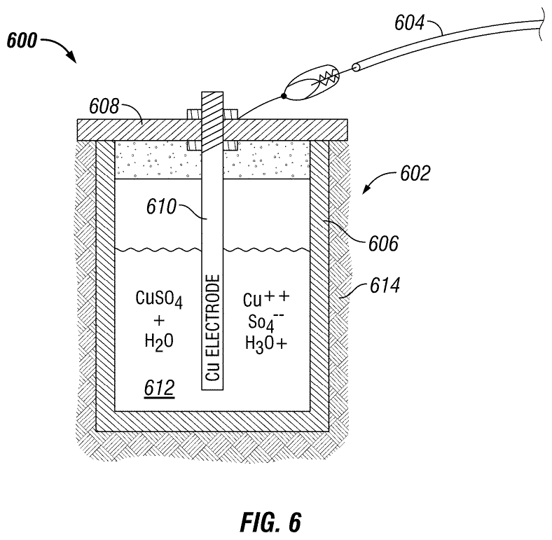

FIG. 6 illustrates an example of a non-polarizing electrode 600. Methods utilizing a non-polarizing electrode 600 may encounter contact resistance from ground conditions, which may vary depending on ground conditions. In examples, contact resistance may be measured and taken into consideration for telemetry measurements. For the purpose of telemetry, the voltage signal amplitude may not be preserved but rather the amplitude-time behavior may be correctly characterized. Stability may be improved by filling the electrode with a kaolinite-rich clay saturated with a CuCO4 solution and by ensuring no copper is exposed to air above the electrolyte.

This disclosure may utilize non-polarizing electrodes in a surface system of EM telemetry system 200. Rather than acquiring electric field data for subsurface resistivity measurements, the non-polarizing electrodes may be used to measure an encoded voltage signal created by a downhole transmitter (not shown). This transmitter may encode data measured downhole in the varying field. Given the broad band nature of the telemetry system, all modern communication schemes for modulation and demodulation may be applicable in this telemetry system. Such scheme may include, but are not limited to: pulse width modulation (PWM), pulse position modulation (PPM), on-off keying (OOK), amplitude modulation (AM), frequency modulation (FM), single-side-band modulation (SSB), frequency shift keying (FSK), phase shift keying (FSK) such as binary phase shift keying (BPSK) and M-ary shift keying, discrete multi-tone (DMT), orthogonal frequency division multiplexing (OFDM), and/or combinations thereof. In example, porous pot sensors, such as, but not limited to a single porous pot electrode may replace metal stake(s) or adjacent wells, multiple porous pot electrodes with manual switching between them by an operator to maximize the signal-to-noise ratio (SNR), multiple porous pot electrodes with automated recommendations to the maximum SNR and with manual switching between them by an operator to maximize the signal-to-noise ratio (SNR), multiple porous pot electrodes with automated switching between them to maximize the SNR. In examples, any of the above may be deployed in an onshore drilling environment (with Cu—CuSO4 preferred) and/or in an offshore drilling environment (with Ag—AgCl).

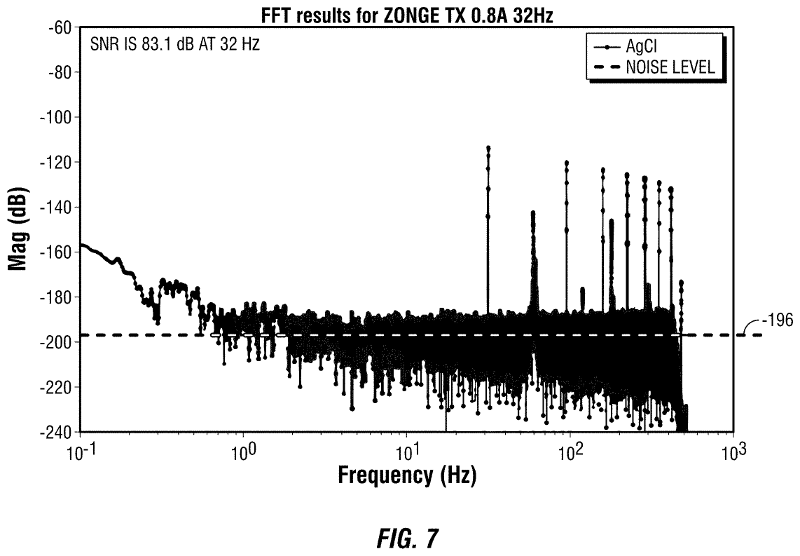

FIG. 7 illustrates an example of data from the Ag—AgCl porous pots for surface sensing of an electric field transmitted from a 500 m long surface-deployed electric bipole transmitter with a square waveform at a base frequency of 32 Hz and peak current of 0.8 A. The base frequency and odd harmonics are observed in the frequency domain, as are the 60 Hz and odd harmonics. The −196 dB level is typical of the instrument noise floor for the voltage sensor. While this configuration is not necessarily typical of EM telemetry, this clearly demonstrates the use of porous pots as electrodes for low noise voltage measurements.

Drilling dynamic data transmitted from BHA 134 (e.g., referring to FIG. 2) to counter electrode 202, a porous pot, which may be attached to information handling system 140 (e.g., referring to FIG. 1). The drilling dynamic data may identify an area in formation 108 (e.g., referring to FIG. 1) which an operator may steer BHA 134 to. In example, information handling system 140 may transmit directions and/or operate BHA 134 to drill toward an identified area in formation 108 during drilling operations.

This method and system may include any of the various features of the compositions, methods, and system disclosed herein, including one or more of the following statements.

Statement 1: A method for communicating with a bottom hole assembly from a surface may comprise drilling into a formation with the bottom hole assembly. The bottom hole assembly may comprise a downhole tool, wherein the downhole tool further comprises at least one transmitter and at least on receiver, a drill string, wherein the drill string is attached to the bottom hole assembly and a well head; and a drill bit, wherein the drill bit is attached to the bottom hole assembly. The method may further comprise disposing at least one porous pot on the surface; emitting an electromagnetic field from the transmitter; sensing a voltage of the electromagnetic field with the at least one porous pot; and measuring the voltage with the porous pot.

Statement 2. The method of statement 1, further comprising calculating a position of the bottom hole assembly in the formation from the voltage.

Statement 3. The method of statement 1 or 2, further comprising changing a direction of the drilling in the formation.

Statement 4. The method of statements 1 to 3, further comprising communicating a position of the bottom hole assembly, a direction of the bottom hole assembly, an angle of the bottom hole assembly, a speed of the bottom hole assembly, or at least one property of the formation.

Statement 5. The method of statements 1 to 4, further comprising placing a well based at least in part on the at least one property of the formation.

Statement 6. The method of statements 1 to 5, wherein the porous pot may include an electro-chemical transducer.

Statement 7. The method of statement 6, wherein the electro-chemical transducer includes silver, lead, or copper.

Statement 8. The method of statements 1 to 6, further comprising encoding data in the voltage

Statement 9. The method of statements 1 to 6 or 8, further comprising measuring the voltage between a first porous pot and a second porous pot.

Statement 10. The method of statements 1 to 6, 8, or 9, further comprising identifying a difference between the voltage at the well head and the at least one porous pot.

Statement 11. A system for communicating with a bottom hole assembly from a surface may comprise a downhole tool, wherein the downhole tool is disposed on the bottom hole assembly. The bottom hole assembly may comprise at least one transmitter, wherein the at least one transmitter is configured to emit an electromagnetic field. The system may further comprise a drill string, wherein the drill string is attached to the bottom hole assembly and a well head, a drill bit, wherein the drill bit is attached to the bottom hole assembly, and at least one porous pot, wherein the at least one porous pot is disposed on the surface and wherein the at least one porous pot is configured to sense and measure a voltage from the electromagnetic field.

Statement 12. The system of statement 11, wherein the voltage is encoded with data.

Statement 13. The system of statement 11 or 12, wherein the data is a position of the bottom hole assembly, a direction of the bottom hole assembly, an angle of the bottom hole assembly, a speed of the bottom hole assembly, or at least one property of the formation.

Statement 14. The system of statements 11 or 12, wherein the at least one porous pot is an electro-chemical transducer.

Statement 15. The system of statements 11, 12, or 14, wherein the electro-chemical transducer includes silver, lead or cooper.

Statement 16. The system of statements 11, 12, or 14, further comprising a wellhead, wherein the wellhead is configured to sense and measure the voltage from the electromagnetic field.

Statement 17. The system of statements 11, 12, 14, or 16, further comprising an information handling system configured to determine a difference between a first voltage at the at least one porous pot and a second voltage at the wellhead.

Statement 18. The system of statements 11, 12, 14, 16, or 17, further comprising a first porous pot, wherein the first porous pot is configured to sense and measure the voltage from the electromagnetic field and a second porous pot, wherein the second porous pot is configured to sense and measure the voltage from the electromagnetic field.

Statement 19. The system of statements 18, further comprising an information handling system configured to determine a difference between a first voltage at the at least one porous pot and a second voltage at the wellhead.

Statement 20. The system of statements 11, 12, 14, 16, 17, or 19, further comprising an information handling system configured to change a direction of the bottom hole assembly. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for communicating with a bottom hole assembly from a surface comprising:
drilling into a formation with the bottom hole assembly, wherein the bottom hole assembly comprises:
a downhole tool, wherein the downhole tool further comprises at least one transmitter and at least on receiver;
a drill string, wherein the drill string is attached to the bottom hole assembly and a well head; and
a drill bit, wherein the drill bit is attached to the bottom hole assembly; and
disposing at least one porous pot on the surface;
emitting an electromagnetic field from the transmitter;
sensing a voltage of the electromagnetic field with the at least one porous pot; and
measuring the voltage with the porous pot.

2. The method of claim 1, further comprising calculating a position of the bottom hole assembly in the formation from the voltage.

3. The method of claim 2, further comprising changing a direction of the drilling in the formation.

4. The method of claim 1, further comprising communicating a position of the bottom hole assembly, a direction of the bottom hole assembly, an angle of the bottom hole assembly, a speed of the bottom hole assembly, or at least one property of the formation.

5. The method of claim 4, further comprising placing a well based at least in part on the at least one property of the formation.

6. The method of claim 1, wherein the porous pot includes an electro-chemical transducer.

7. The method of claim 6, wherein the electro-chemical transducer includes silver, lead, or copper.

8. The method of claim 1, further comprising encoding data in the voltage

9. The method of claim 1, further comprising measuring the voltage between a first porous pot and a second porous pot.

10. The method of claim 1, further comprising identifying a difference between the voltage at the well head and the at least one porous pot.

11. A system for communicating with a bottom hole assembly from a surface comprising:
a downhole tool, wherein the downhole tool is disposed on the bottom hole assembly and wherein the downhole tool further comprises:
at least one transmitter, wherein the at least one transmitter is configured to emit an electromagnetic field;
a drill string, wherein the drill string is attached to the bottom hole assembly and a well head;
a drill bit, wherein the drill bit is attached to the bottom hole assembly; and
at least one porous pot, wherein the at least one porous pot is disposed on the surface and wherein the at least one porous pot is configured to sense and measure a voltage from the electromagnetic field.

12. The system of claim 11, wherein the voltage is encoded with data.

13. The system of claim 12, wherein the data is a position of the bottom hole assembly, a direction of the bottom hole assembly, an angle of the bottom hole assembly, a speed of the bottom hole assembly, or at least one property of the formation.

14. The system of claim 11, wherein the at least one porous pot is an electro-chemical transducer.

15. The system of claim 14, wherein the electro-chemical transducer includes silver, lead or cooper.

16. The system of claim 11, further comprising a wellhead, wherein the wellhead is configured to sense and measure the voltage from the electromagnetic field.

17. The system of claim 16, further comprising an information handling system configured to determine a difference between a first voltage at the at least one porous pot and a second voltage at the wellhead.

18. The system of claim 11, further comprising a first porous pot, wherein the first porous pot is configured to sense and measure the voltage from the electromagnetic field and a second porous pot, wherein the second porous pot is configured to sense and measure the voltage from the electromagnetic field.

19. The system of claim 18, further comprising an information handling system configured to determine a difference between a first voltage at the at least one porous pot and a second voltage at the wellhead.

20. The system of claim 11, further comprising an information handling system configured to change a direction of the bottom hole assembly.
